(19) United States
(12) Patent Application Publication
(10) Pub. No.: US 2013/0029144 A1
(43) Pub. Date: Jan. 31, 2013

(54) Self-Adhesive Notepaper Film

(71) Applicant: David C.T. Jour, Taipei (TW)

(72) Inventor: David C.T. Jour, Taipei (TW)

(21) Appl. No.: 13/191,408

(22) Filed: Jul. 26, 2011

(51) Int. Cl. B32B 7/12

(52) U.S. Cl. 428/354

(57) ABSTRACT

A self-adhesive notepaper film, which is used. to address the shortcomings of common notepaper including: possible curling and disengagement from attached surface; the self-adhesive notepaper film comprises: paperwood, plastic film and viscose glue; the paperwood is fully mated. with the plastic film, and the viscose glue is partially or fully applied to the other surface of the plastic film for the purpose of adhesion; multiple sheets of aforementioned self-adhesive notepaper film are overlapped for easy and repetitive access; as the paperwood is mated with the plastic film, and the elasticity of the plastic film is bigger than the residual stress on the surface of the paperwood, the self-adhesive notepaper film could be attached firmly on the object without curling.

### BACKGROUND OF INVENTION

1. Field of the Invention

The present invention relates generally to an improved structure of notepaper, and more particularly to an innovative one which is designed with self-adhesive notepaper film.

2. Description of Related Art

Viscose glue is coated onto the surface of common notepaper, and then multiple notepaper sheets are overlapped to form a notepaper set; while tearing the notepaper, the internal fiber of the notepaper will be damaged, leading to possible curling of the notepaper.

When the notepaper is torn out and attached onto the object, the curling notepaper will affect the adhesion of viscose glue, leading to disengagement of the viscose glue from the attached. surface due to damage of the fiber.

In view of existing shortcomings of common notepaper, the inventor has design and developed a utility model of “self-adhesive notepaper film” for general use.

### SUMMARY OF THE INVENTION

The primary objective of the present invention is to provide a self-adhesive notepaper film, which could prevent curling or disengagement from the attached surface when tearing out the notepaper.

Technical means are adopted to design a self-adhesive notepaper film, which comprising: paperwood, plastic film and viscose glue; the paperwood is fully mated with the plastic film, and the viscose glue is partially or fully applied to the other surface of the plastic film, such that the viscose glue is used for adhesion and the paperwood for writing; a complete, single self-adhesive notepaper film is thus formed in this way. Multiple sheets of self-adhesive notepaper film are overlapped to form a self-adhesive notepaper film set of economic applicability; when tearing out a single self-adhesive notepaper film, the minor damage and curling of the notepaper could not lead to curling effect of the self-adhesive notepaper film, and the self-adhesive notepaper film could be attached firmly onto the object since the paperwood is mated with the plastic film, and the elasticity of plastic film is bigger than the residual stress of paperwood.

The features and advantages of the present invention will be more readily understood upon the following detailed description of a preferred embodiment of the present invention with reference to the accompanying drawings.

### BRIEF DESCRIPTION OF THE DRAWINGS

FIG. 1: an exploded view of the preferred embodiment of the self-adhesive notepaper film of the present invention;

FIG. 2: an external view of the preferred embodiment of the self-adhesive notepaper film of the present invention;

FIG. 3: a sectional view of the preferred embodiment of the self-adhesive notepaper film of the present invention;

FIG. 4: a schematic view of the preferred embodiment of the present invention that multiple sheets of self-adhesive notepaper film are overlapped.

### DETAILED DESCRIPTION OF THE INVENTION

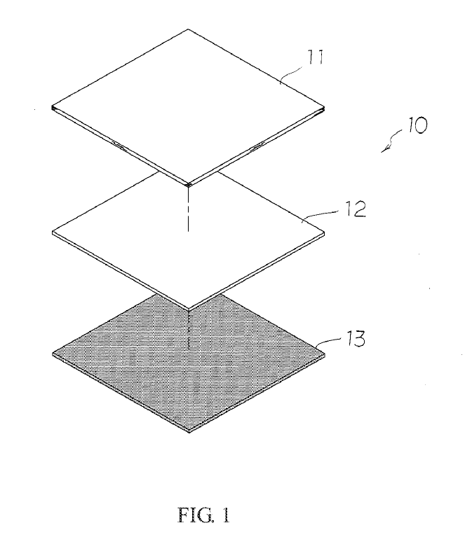

FIG. 1 discloses an exploded view of the preferred embodiment of the self-adhesive notepaper film of the present invention, wherein a single self-adhesive notepaper film 10 comprises: a paperwood 11, plastic film 12 and viscose glue 13.

Firstly, the plastic film 12 is mated. with the paperwood 11, then the viscose glue 13 is applied to the other surface of the plastic film 12, thus forming a brand. new self-adhesive notepaper film 10.

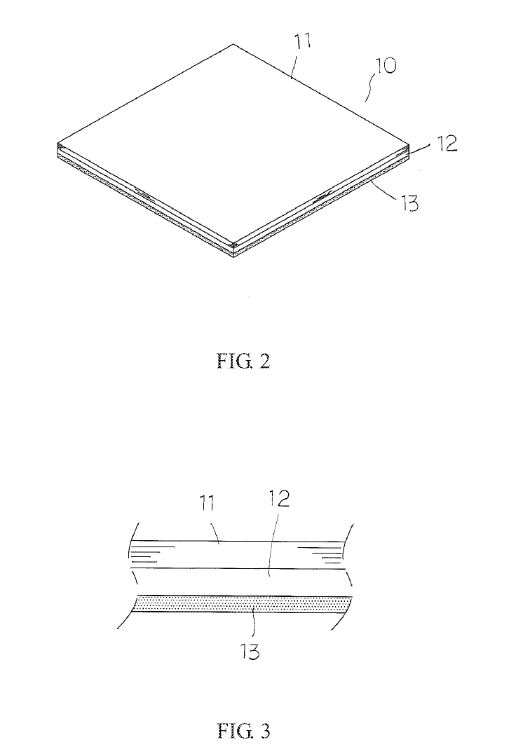

FIG. 2 discloses an external view of the preferred embodiment of the self-adhesive notepaper film of the present invention, wherein the paperwood 11, plastic film 12 and viscose glue 13 are implemented as per aforementioned. modes, so as to obtain a complete self-adhesive notepaper film 10.

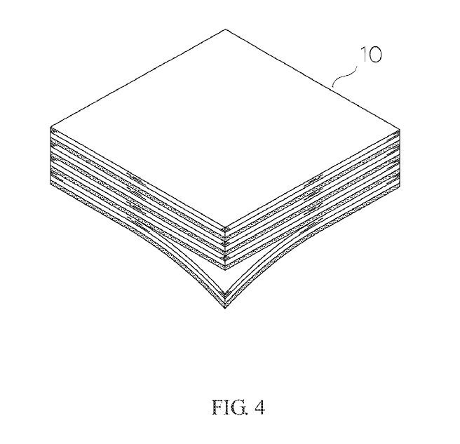

FIG. 3 discloses a sectional view of the preferred embodiment of the self-adhesive notepaper film of the present invention, wherein the self-adhesive notepaper film 10 is of a composite layer covering the paperwood 11 and plastic film 12; and by taking the plastic film 12 as its center, the paperwood 11 is attached on its upper surface, and the viscose glue 13 applied on its lower surface; no stress damage occurs due to absence of fiber tissue of the plastic film 12; as the residual stress on the surface of the paperwood 11 is much smaller than the elasticity of the plastic film 12, the self-adhesive notepaper film 10 could be attached firmly on the object without curling when it is torn out and attached on any surface.

FIG. 4 discloses a schematic view of the preferred embodiment of the self-adhesive notepaper film of the present invention, wherein multiple sheets of self-adhesive notepaper film 10 are overlapped so as to form a complete self-adhesive notepaper film set that can be torn out several times to realize economic benefits for the users.

To sum up, as the present invention is an innovative product of excellent industrial applicability and benefits complying with the spirit of new patents, the patent claims are made hereto.

The above is a detailed description of the technical features of the present invention based on a typical preferred embodiment. However, it should be appreciated that the present invention is capable of a variety of embodiments and various modifications, and all such variations or changes shall be embraced within the scope of the following claims.

1. A self-adhesive notepaper film, which comprising:
a paperwood, used for writing;
a plastic film, fully covered onto surface of the paperwood; and
a viscose glue, applied to the other surface of the plastic film mated with the paperwood.

2. The self-adhesive notepaper film as claimed in claim 1, wherein said viscose glue is partially applied to the surface of the plastic film.

3. The self-adhesive notepaper film as claimed in claim 1, wherein said viscose glue is fully applied to the surface of the plastic film.

4. A self-adhesive notepaper film set, which comprising: multiple sheets of self-adhesive notepaper film overlapped as claimed in claim 1.
